(19) United States
(12) Patent Application Publication
(10) Pub. No.: US 2011/0014959 A1
(43) Pub. Date: Jan. 20, 2011

(54) Antenna Array Isolation For A Multiple Channel Communication System

(75) Inventors: Mohammad A. Tassoudji, San Diego, CA (US); Hemanth Sampath, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/505,318

(22) Filed: Jul. 17, 2009

(51) Int. Cl. H04M 1/00

(52) U.S. Cl. 455/575.7

(57) ABSTRACT

A multi-channel wireless communication device includes first and second antenna elements. The first antenna element, being of a first type, transmits and receives a first wireless communication signal over a first predetermined wireless channel. The second antenna element, being of a second type different than the first type, transmits and receives a second wireless communication signal over a second predetermined wireless channel, different from the first predetermined wireless channel.

### FIELD OF THE INVENTION

The present disclosure relates generally to communication systems, and, more particularly, to isolation between antenna elements of an antenna array for use with a multiple channel communication system.

### BACKGROUND OF THE INVENTION

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality. A wireless communication device may be referred to as a mobile station, a subscriber station, an access terminal, a remote station, a user terminal, a terminal, a subscriber unit, user equipment, etc. The term “subscriber station” will be used herein.

A wireless communication system may provide communication for a number of cells, each of which may be serviced by a base station. A base station may be a fixed station that communicates with mobile stations. A base station may alternatively be referred to as an access point, a modem, or some other terminology.

A subscriber station may communicate with one or more base stations via transmissions on the uplink and the downlink. The uplink (or reverse link) refers to the communication link from the subscriber station to the base station, and the downlink (or forward link) refers to the communication link from the base station to the subscriber station. A wireless communication system may simultaneously support communication for multiple subscriber stations.

Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, orthogonal frequency division multiple access (OFDMA) systems, and spatial division multiple access (SDMA).

The IEEE 802.11 group is currently looking into standardizing a new version of 802.11, under the name 802.11ac or the VHT (Very High Throughput) Task Group. In 802.11ac, more than 1 gigabits-per-second (Gbps) Medium Access Control (MAC) throughput may be achieved in the 5 gigahertz (GHz) band. Technologies are being considered in this group which use higher order multiple input multiple output (MIMO), SDMA, and OFDMA over multiple 20 megahertz (MHz) channels.

There are approximately twenty-four 20 megahertz (MHz) frequency channels in the 5 gigahertz (GHz) spectrum that may be used for WLAN communications. Multi-channel modems that can operate over multiple 20 MHZ frequency channels may be attractive for 802.11ac. The 5 GHz spectrum plan for the United States is illustrated below in Table 1.

TABLE 1

| | | | | Maximum | |
|---|---|---|---|---|---|
| | Channel | Transmit | | Transmit | Potential |
| Frequency | Number | Frequency | | Power | Radar |
| U-NII lower | 36 | 5.180 | GHz | 50 mW Tx | No |
| band | 40 | 5.200 | GHz | Power; 23 | |
| | 44 | 5.220 | GHz | dBm EIRP | |
| | 48 | 5.240 | GHz | | |
| U-NII middle | 52 | 5.260 | GHz | 250 mW | Yes |
| band | 56 | 5.280 | GHz | TxPower; | |
| | 60 | 5.300 | GHz | 30 dBm | |
| | 64 | 5.320 | GHz | EIRP | |
| U-NII middle- | 12 | 5.47-5.725 | GHz | 250 mW | |
| upper band | channels | | | | |
| U-NII upper | 149 | 5.745 | GHz | 1000 mW Tx | No |
| band | 153 | 5.765 | GHz | Power; | |
| | 157 | 5.785 | GHz | 36 dBm | |
| | 161 | 5.805 | GHz | EIRP | |

Each station may use up to approximately 24 frequency channels. A client such as a subscriber station may have a smaller multichannel capability compared to an access point. An access point may typically use up to four 20 MHz channels. In contrast, a client may use any one of the 20 MHz channels. Each 20 MHz channel may be referred to as a basic channel. One or more contiguous basic channels may collectively be referred to as a VHT channel. For example, a VHT channel may be 80 MHz wide having four 20 MHz channels.

VHT channels may be separated in bandwidth to guard against channel de-sensing. In a given multi-channel modem, the transmitter in one VHT channel A may transmit signals at 20 dBm (decibels referenced to one milliwatt). The receiver in another VHT channel B may simultaneously and independently receive signals at −90 dBm. In such a situation, the transmit signal may leak into the receiver and saturate the receiver front end, creating receiver distortion. This effect is called channel de-sensing.

Typically, channel de-sensing may be alleviated by sufficient RF filtering and adequate frequency channel spacing. For example, RF filtering is achieved using bulk acoustic wave (BAW) filter and analog filters that can typically provide attenuation of 40 dB and 50 dB respectively, assuming frequency channel spacing of say 100 MHz. It can be seen that the transmit signal A leaks into the receiver even after RF filter attentuation of 50+40=90 dB, and arrives at a signal level =−70 dBm at the input to the ADC of the receiver.

It can be seen that antenna isolation of greater than 20 dB further between VHT channels A and B is needed to further suppress the leaked transmit signal level to −90 dBm. Antenna isolation between different frequency channels in a multi-channel modem is hence an important method to achieve channel de-sensing. Good antenna isolation also reduces RF filtering costs and design constraints. There is a need for antenna designs for multi-channel modems that provide sufficient isolation (20+ dB) in small form-factor devices. In addition, it is desirable for convenience of cable distribution to/from antenna array to keep the antennas in close proximity to processing logic.

When designing multiple channel antenna arrays, several other parameters also may be considered, such as: the leakage, return loss, isolation, correlation, Eigenvalues, radiation pattern, efficiency, directivity, mechanical design, etc.

Further limitations and disadvantages of conventional and traditional approaches will become apparent to one of skill in the art of multiple channel communication systems and devices, through comparison of such systems and devices with some aspects of the present invention, as set forth in the remainder of the present disclosure with reference to the drawings.

### SUMMARY OF THE INVENTION

A multi-channel wireless communication device includes first and second antenna elements and a radio transceiver. The first antenna element, being of a first type, transmits and receives a first wireless communication signal over a first predetermined wireless channel. The second antenna element, being of a second type different than the first type, transmits and receives a second wireless communication signal over a second predetermined wireless channel, different from the first predetermined wireless channel.

According to other aspects of the present invention, the present invention may employ an antenna array, an apparatus, and associated means.

These and other aspects of the present invention will be apparent from the accompanying drawings and from the following detailed description.

### BRIEF DESCRIPTION OF THE DRAWINGS

So that the manner in which the above recited features of the present disclosure may be understood in detail, a more particular description, briefly summarized above, may be had by reference to embodiments, some of which are illustrated in the appended drawings, in which like reference numbers designate corresponding elements. It is to be noted, however, that the appended drawings illustrate only certain typical embodiments of this disclosure and are therefore not to be considered limiting of its scope, for the description may admit to other equally effective embodiments.

FIG. 1 illustrates a system including an access point in wireless electronic communication with multiple subscriber stations.

FIG. 2 illustrates a system including an access point in wireless electronic communication with multiple subscriber stations, where aliasing may occur.

FIG. 3 illustrates an example of a very high throughput (VHT) channel configuration.

FIG. 4 is a block diagram illustrating the front-end architecture for an access point or a subscriber station.

### DETAILED DESCRIPTION

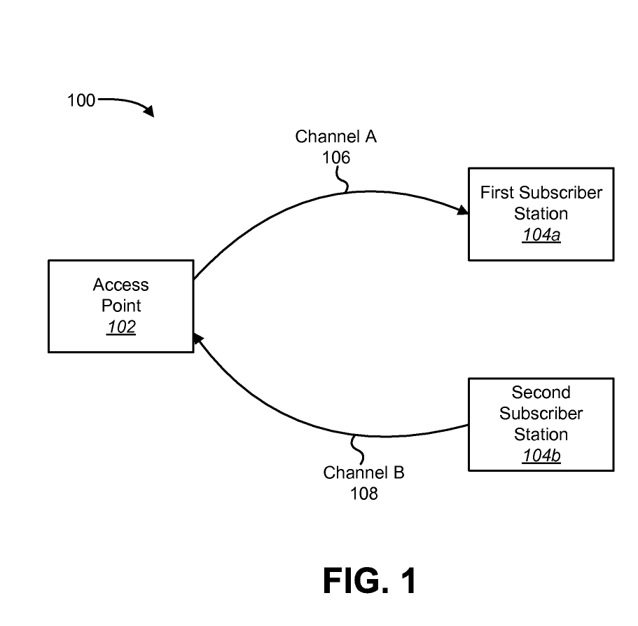

FIG. 1 illustrates a system 100 including an access point 102 in wireless electronic communication with multiple subscriber stations 104. The access point 102 may be a base station. The subscriber stations 104 may be mobile stations such as mobile phones and wireless networking cards.

The access point 102 may communicate with each of the subscriber stations 104. For example, the access point 102 may send data to the subscriber stations 104 over a downlink transmission. Similarly, the subscriber stations 104 may send data to the access point 102 over an uplink transmission. The subscriber stations 104 may receive transmissions from the access point 102 that are not directed to the specific subscriber station 104. For example, the access point 102 may send a downlink transmission to a first subscriber station 104a that may also be received by a second subscriber station 104b. Similarly, subscriber stations 104 may receive uplink transmissions from other subscriber stations 104 that are not directed to the other subscriber stations 104. For example, the second subscriber station 104b may send an uplink transmission to the access point 102 that may also be received by the first subscriber station 104a.

The access point 102 may send transmissions to the first subscriber station 104a over a first frequency channel 106. For example, the access point 102 may send transmissions to the first subscriber station 104a over frequency channel A. The access point 102 may receive transmissions from the second subscriber station 104b over a second frequency channel 108. For example, the access point 102 may receive transmissions from the second subscriber station 104b over frequency channel B.

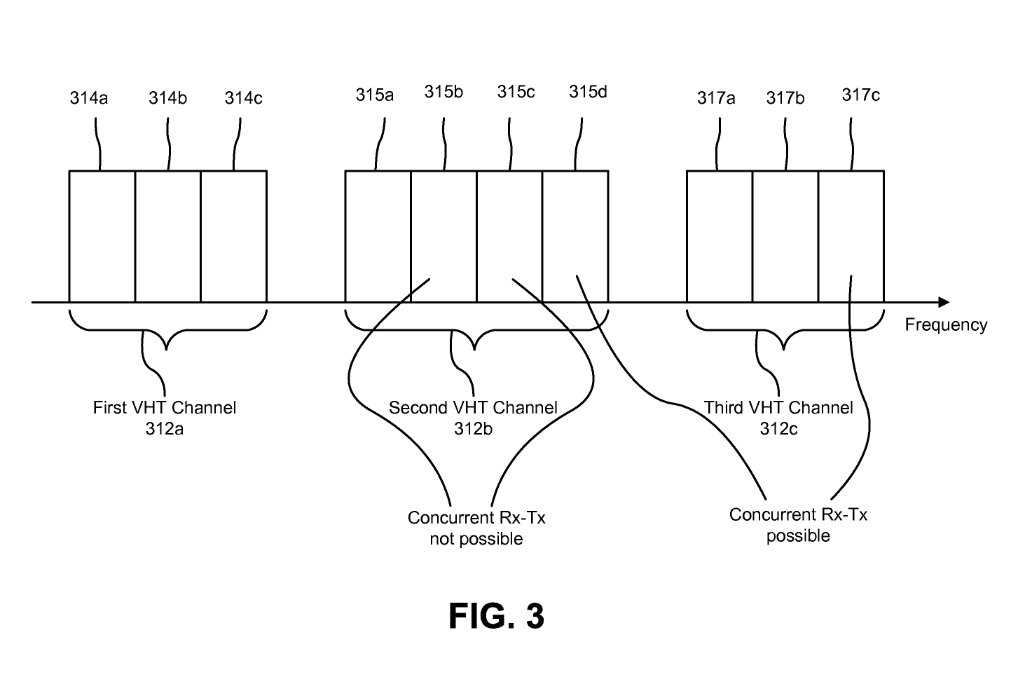

One or more contiguous basic channels may collectively be referred to as a VHT channel. For example, a VHT channel may be 80 MHz wide having four 20 MHz channels. It may be assumed that a modem can either transmit synchronously across one or more basic channels in a VHT channel, or receive synchronously across one or more basic channels in a VHT channel. In other words, a modem cannot transmit on one basic channel and receive on another basic channel within a single given VHT channel. This is because of radio frequency (RF) considerations as explained in further detail below in relation to FIG. 3.

The 802.11n standard describes a procedure for a modem to transmit synchronously on a 40 MHz channel (i.e. two contiguous 20 MHz channels). For this procedure, a modem may sense the 40 MHz channel for a point coordination function (PCF) inter-frame space (PIFS) (approximately 25 microseconds). If no transmissions are detected (i.e. the channel is free), the modem may transmit data on the 40 MHz channel. This may be referred to as the PIFS access procedure. A modem may employ the PIFS access procedure to transmit a signal across all basic channels in a VHT channel. The access point 102 may asynchronously transmit and receive across multiple VHT channels simultaneously in the 5 GHz spectrum.

VHT channels may be separated in bandwidth to guard against channel de-sensing. In a given multi-channel modem, the transmitter in one VHT channel may transmit signals at 20 dBm (decibels referenced to one milliwatt). The receiver in another VHT channel may simultaneously receive signals at −90 dBm. In such a situation, the transmit signal may leak into the receiver and saturate the receiver front end, creating receiver distortion. This effect is called channel de-sensing. Typically, channel de-sensing may be alleviated by sufficient RF filtering and antenna isolation between transmit and receive modems. To guard against channel de-sensing, VHT channels may be separated by a bandwidth separation of approximately 100 MHz. The exact bandwidth separation may be determined by design constraints. For example, the exact bandwidth separation may depend on the costs and capabilities of RF filters that are employed at the transmitter and the receiver to create isolation.

In addition to channel de-sensing, the transmit signal may also alias into the receiver signal after analog to digital conversion. This may also create distortion. Techniques to mitigate this aliasing problem referred to as the self-interference problem may be performed.

A subscriber station 104 may be restricted to using only a subset of VHT channels used by the access point 102. For example, a subscriber station 104 may be restricted to using only a single VHT channel.

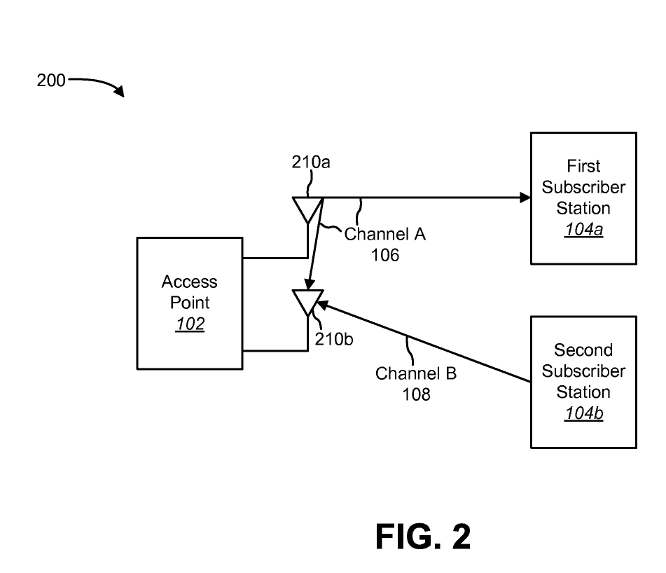

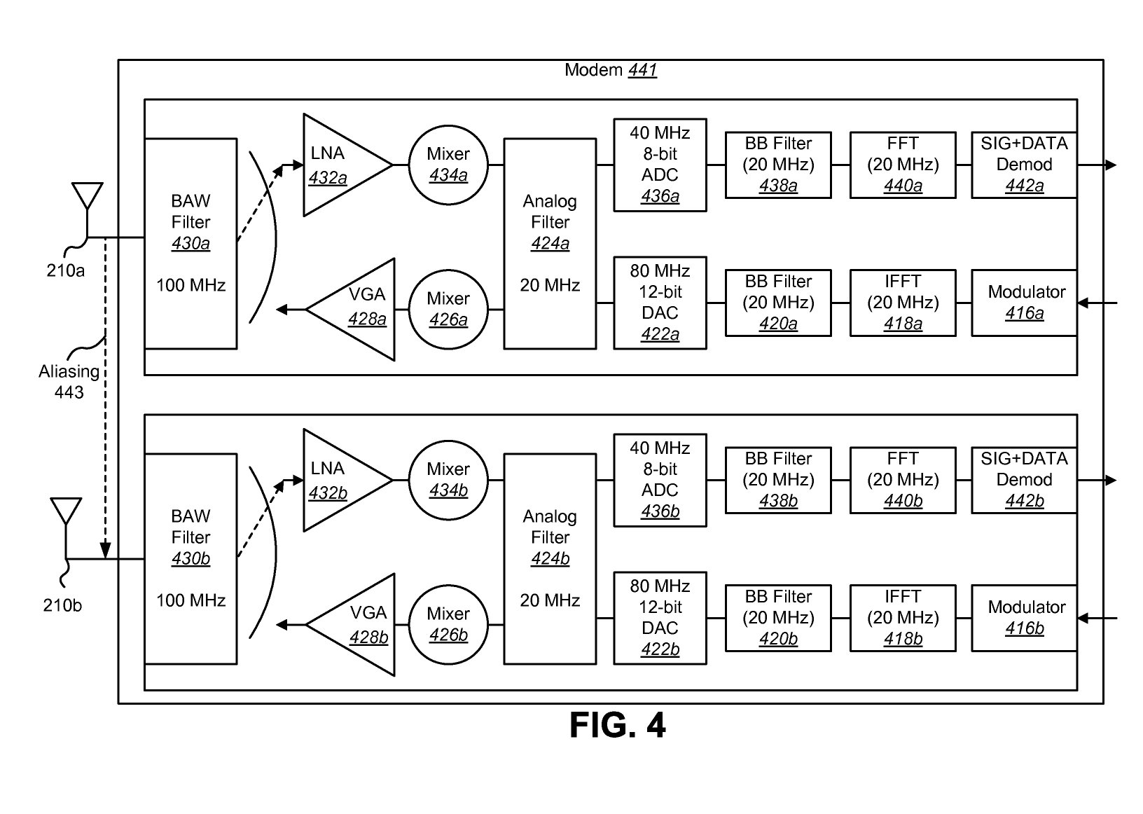

FIG. 2 illustrates a system 200 including an access point 102 in wireless communication with multiple subscriber stations 104 where aliasing may occur. The access point 102 may use a first antenna 210a to transmit signals to the first subscriber station 104a on the first channel 106, which is referred to as channel A. The access point 102 may use a second antenna 210b to receive signals from the second subscriber station 104b on the second channel 108, which is referred to as channel B. Channel A and channel B are on different VHT channels. Both the transmitter and the receiver on the access point 102 may include a bulk acoustic wave (BAW) filter. A BAW filter is a type of passband RF filter, with the transmit frequency or the receive frequency as the center frequency. The front end architecture for a single input single output (SISO) access point 102 is discussed in further detail below in relation to FIG. 4.

ADC sampling may cause aliasing of transmit frequency channels from other bands. For example, ADC sampling may cause aliasing of the transmit channel A image on to the receive channel B. Aliasing of a channel A image on to channel B may occur if the spectral content of channel B is in the range as shown by Equation (1), as follows:

[fc+/−n*fs−W_{A}/2, n*fs+W_{A}/2]

fc+/−[n*fs−W_{A}/2, n*fs+W_{A}/2] (1)

where n=0, 1, 2 . . . , fs is the ADC sampling rate, W_{A} is the bandwidth of Channel A, and fc is the center frequency of channel A with respect to channel B.

FIG. 3 illustrates examples of VHT channel 312 configurations. Each VHT channel 312 may include one or more adjacent basic channels. Each basic channel may be a 20 MHz channel. For example, a first VHT channel 312a may include three adjacent 20 MHz basic channels, a first VHT channel first basic channel 314a, a first VHT channel second basic channel 314b, and a first VHT channel third basic channel 314c. As another example, a second VHT channel 312b may include four adjacent 20 MHz basic channels, a second VHT channel first basic channel 315a, a second VHT channel second basic channel 315b, a second VHT channel third basic channel 315c, and a second VHT channel fourth basic channel 315d. As another example, a third VHT channel 312c may include three adjacent 20 MHz basic channels, a third VHT channel first basic channel 317a, a third VHT channel second basic channel 317b, and a third VHT channel third basic channel 317c.

As discussed above, an access point 102 or a modem may transmit and receive concurrently on different VHT channels. For example, the access point 102 may receive on the first VHT channel first basic channel 314a while concurrently transmitting on the second VHT channel first basic channel 315a. Concurrent transmission and reception by the access point 102 may be possible if the access point 102 transmits on a basic channel that is part of a different VHT channel 312 than the channel the access point 102 is concurrently receiving on (e.g., transmitting on a basic channel 314 of the first VHT channel 312a while receiving on a basic channel 315 of the second VHT channel 312b). Concurrent transmission and reception may not be possible if transmission and reception occur on basic channels that are both part of the same VHT channel 312 (e.g., attempting to transmit on the first basic channel 314a of the first VHT channel 312a and attempting to receive on the second basic channel 314b of the first VHT channel 312a).

The bandwidth for each VHT channel 312 may be dependent on the cost of the radio frequency (RF) bulk acoustic wave (BAW) filters. If a VHT channel 312 includes three basic channels, the bandwidth of the VHT channel 312 may be 60 MHz. Likewise, if a VHT channel 312 includes five basic channels, the bandwidth of the VHT channel 312 may be 100 MHz.

Due to RF front-end limitations, a subscriber station 104 and/or an access point 102 transmitting on one or more basic channels within a VHT channel 312 may be unable to listen to the other basic channels within the same VHT channel 312. This may be due to the channel de-sensing of the basic channel in receive mode. Furthermore, a subscriber station 104 and/or an access point 102 may be unable to monitor the network allocation vectors (NAVs) on multiple basic channels within the same VHT channel 312, which may limit subsequent throughput gains because the access point 102 would be deaf on secondary channel traffic while transmitting on the primary channel. This may be due to the large power imbalance of packets received from different users on different basic channels, necessitating a prohibitively high 17 bits of ADC. To transmit on one VHT channel 312a while simultaneously receiving on another VHT channel 312b, front-end (RF) BAW filtering may be necessary. Due to cost considerations, access points 102 may be more likely to support a larger number of VHT channels 312 than clients. The capability of the access point 102 to transmit and receive simultaneously may incur additional RF filtering costs and requirements.

FIG. 4 is a block diagram illustrating a configuration of the front-end architecture for a modem 441. The modem 441 may be part of a wireless device such as an access point or a subscriber station. The modem 441 may be operating in a single input single output (SISO) mode. It may be assumed for purposes of FIG. 4 that each VHT channel is 20 MHz, and that the transmitter is operating on channel A, whereas the receiver is operating on channel B. A transmission signal stream may be sent through a modulator 416a, 416b to module the signal in order to prepare the signal stream for conveying a message. An inverse fast Fourier transform (IFFT) 418a, 418b may convert the signal stream from the frequency domain to the time domain. A baseband filter 420a, 420b may filter out the undesired high frequency images. A digital-to-analog convertor (DAC) 422a, 422b may convert the digital signal stream to an analog signal stream and an analog filter 424a, 424b may provide additional filtering to the signal stream to further reduce the higher frequency images.

A mixer 426a, 426b may convert the analog baseband signal to RF frequencies. A variable gain amplifier (VGA) 428a, 428b may maintain a desired output signal level by controlling the gain of the signal stream. Finally, the signal stream may be passed through a Bulk Acoustic Wave (BAW) filter 430a, 430b before being transmitted by an antenna 210a, 210b. The BAW filter is an RF passband filter at the center frequency of channel A with a stopband that further suppresses the high frequency images, so that the images are well below the noise floor (approximately −90 dBm) of the receiver for channel B.

Similarly, a received signal stream from an antenna 210a, 210b may be sent through a BAW filter 430a, 430b. If the transmitter signal power on channel A is 20 dBm, a 40 dB suppression achieved by the BAW filter 430a, 430b may result in the transmit signal power of channel A leaking on to the channel B receiver at a power level of approximately −20 dBm. This signal level is below the saturation region of the Low-Noise Amplifier (LNA) 432a, 432b at the RF front-end of the channel B receiver.

The LNA 432a, 432b may amplify weak signals captured by the antenna 210a, 210b. A mixer 434a, 434b may then convert the RF signal to baseband signals. An analog filter 424a, 424b may provide further suppression of about 50 dB to the channel A transmitter signals leaking into the channel B receiver. This may result in the transmit signal power of channel A leaking on to the channel B receiver at a power level of approximately −70 dBm. To further suppress this leaked signal, Channel A and channel B may require a separate physical antenna 210 with 2-3 lambda spacing to ensure approximately 20 dB of isolation, although any spacing may be used. An ADC (analog-to-digital converter) 436a, 436b converts the signal from analog to digital. A baseband filter 438a, 438b provides further baseband filtering of channel A transmit signals leaking into the channel B receiver. A fast Fourier transform (FFT) 440a, 440b converts the signal stream from the time domain to the frequency domain, and the time demodulation engine 442a, 442b demodulates the resulting signal.

In order to satisfy the system requirements and choose a suitable antenna, system engineers evaluate an antenna's performance. Typical descriptions, metrics or parameters used in evaluating an antenna include, for example, the input impedance, polarization, radiation efficiency, directivity, gain, radiation pattern, bandwidth, leakage, return loss, isolation, coupling, correlation, Eigenvalues, mechanical design, size, cost, and manufacturabilty, etc.

In order to achieve the 20+ dB isolation between individual antenna arrays employed by a multi-channel device, several techniques may be used. Any combination or number of isolation techniques, designs, including the using any of the metrics and parameters described above, may be employed to achieve a desired or specified isolation.

According to one aspect of the present invention, the isolation may be achieved by employing antenna elements of different types. The different types of antennas may be of any type. For example, individual antenna elements may be any type of antenna including, without limitation, a slot antenna, a ceramic chip antenna, a monopole antenna, a planar inverted F antenna (PIFA), a wire inverted F antenna, and a donut antenna.

According to other aspects of the present invention, the isolation may be achieved by employing antenna elements of different radiation patterns, different polarization, different radiation directions, and different locations.

The techniques presented herein may allow for compact arrays that may be incorporated into such devices to increase data throughput, while providing desirable isolation, for applications running on such devices in a multiple channel communication system.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that may be accessed by a computer. By way of example, and not limitation, such computer-readable media can comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein may be downloaded and/or otherwise obtained by a user terminal and/or base station as applicable. For example, such a device may be coupled to a server to facilitate the transfer of means for performing the methods described herein. Alternatively, various methods described herein may be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device may be utilized.

The description and drawings are illustrative of aspects and examples of the invention and are not to be construed as limiting the invention. The word “exemplary” is used herein to mean “serving as an example, instance, or illustration.” Any embodiment described herein as “exemplary” is not necessarily to be construed as preferred or advantageous over other aspects.

Numerous specific details are described to provide a thorough understanding of the present invention. However, in certain instances, well-known or conventional details are not described in order to avoid obscuring the description of the present invention. References to one embodiment or an embodiment in the present disclosure are not necessarily to the same embodiment, and such references may include one or more embodiments.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A multi-channel wireless communication device comprising:
a first antenna element, being of a first type, for transmitting and receiving a first wireless communication signal over a first predetermined wireless channel; and
a second antenna element, being of a second type different than the first type, for transmitting and receiving a second wireless communication signal over a second predetermined wireless channel, different from the first predetermined wireless channel.

2. The multi-channel wireless communication device of claim 1,
wherein the first antenna element, being of the first type, has a first radiation pattern, and
wherein the second antenna element, being of the second type, has a second radiation pattern different from the first radiation pattern.

3. The multi-channel wireless communication device of claim 1,
wherein the first antenna element, being of the first type, has a first polarization, and
wherein the second antenna element, being of the second type, has a second polarization different from the first polarization.

4. The multi-channel wireless communication device of claim 1,
wherein the first antenna element, being of the first type, radiates in a first direction, and
wherein the second antenna element, being of the second type, radiates in a second direction different from the first direction.

5. The multi-channel wireless communication device of claim 1 wherein the first antenna element, being of the first type, further comprise one of the following types of antennas:
a slot antenna, a ceramic chip antenna, a monopole antenna, a planar inverted F antenna (PIFA), a wire inverted F antenna, and a donut antenna.

6. The multi-channel wireless communication device of claim 1 wherein the second antenna element, being of the second type, further comprise one of the following types of antennas:
a slot antenna, a ceramic chip antenna, a monopole antenna, a planar inverted F antenna (PIFA), a wire inverted F antenna, and a donut antenna.

7. The multichannel wireless communication device of claim 1 wherein the first and second predetermined wireless channels are wireless frequency sub-bands selected from 2.4 GHz and 5 GHz wireless bands.

8. The multichannel wireless communication device of claim 1 wherein the wireless communication device is a multi-channel wireless access point for a wireless local area network, wherein the multi-channel wireless access point is in communication with a plurality of wireless subscriber stations.

9. The multichannel wireless communication device of claim 1 wherein the wireless communication device is a multi-channel wireless subscriber station for a wireless local area network, wherein the multi-channel wireless subscriber station is in communication with a one or more multi-channel wireless access points.

10. The multichannel wireless communication device of claim 1 wherein the first and second antenna elements are ones of a respective plurality of pairs of antenna elements, for transmitting and receiving respective wireless telecommunications signals over respective predetermined wireless channels.

11. The multi-channel wireless communication device of claim 1 wherein the first and second antenna elements are configured so that as one of the first and second antenna elements is transmitting a wireless signal, the respective other one of the first and second antenna elements is receiving a wireless signal.

12. The multi-channel wireless communication device of claim 1 further comprising:
a radio frequency (RF) transceiver for generating the respective first and second wireless communication signals.

13. The multi-channel wireless communication device of claim 12 wherein the RF transceiver further comprises:
a first transmitter and a first receiver coupled to the first antenna; and
a second transmitter and a second receiver coupled to the second antenna.

14. A multi-channel wireless communication device comprising:
a first antenna element, being of a first type, for transmitting and receiving a first wireless communication signal over a first predetermined wireless channel; wherein the first antenna element, being of the first type, has a first radiation pattern, has a first polarization, and radiates in a first direction; and
a second antenna element, being of a second type different than the first type, for transmitting and receiving a second wireless communication signal over a second predetermined wireless channel, different from the first predetermined wireless channel, wherein the second antenna element, being of the second type, has a second radiation pattern different from the first radiation pattern, has a second polarization different from the first polarization, and radiates in a second direction different from the first direction.

15. The multi-channel wireless communication device of claim 14 wherein the first antenna element, being of the first type, further comprise one of the following types of antennas:
a slot antenna, a ceramic chip antenna, a monopole antenna, a planar inverted F antenna (PIFA), a wire inverted F antenna, and a donut antenna.

16. The multi-channel wireless communication device of claim 14 wherein the second antenna element, being of the second type, further comprise one of the following types of antennas:
a slot antenna, a ceramic chip antenna, a monopole antenna, a planar inverted F antenna (PIFA), a wire inverted F antenna, and a donut antenna.

17. The multichannel wireless communication device of claim 14 wherein the first and second predetermined wireless channels are wireless frequency sub-bands selected from 2.4 GHz and 5 GHz wireless bands.

18. The multichannel wireless communication device of claim 14 wherein the wireless communication device is a multi-channel wireless access point for a wireless local area network, wherein the multi-channel wireless access point is in communication with a plurality of wireless subscriber stations.

19. The multichannel wireless communication device of claim 14 wherein the wireless communication device is a multi-channel wireless subscriber station for a wireless local area network, wherein the multi-channel wireless subscriber station is in communication with a one or more multi-channel wireless access points.

20. The multichannel wireless communication device of claim 14 wherein the first and second antenna elements are ones of a respective plurality of pairs of antenna elements, for transmitting and receiving respective wireless telecommunications signals over respective predetermined wireless channels.

21. The multi-channel wireless communication device of claim 14 wherein the first and second antenna elements are configured so that as one of the first and second antenna elements is transmitting a wireless signal, the respective other one of the first and second antenna elements is receiving a wireless signal.

22. The multi-channel wireless communication device of claim 14 further comprising:
a radio frequency (RF) transceiver for generating the respective first and second wireless communication signals.

23. The multi-channel wireless communication device of claim 22 wherein the RF transceiver further comprises:
a first transmitter and a first receiver coupled to the first antenna; and
a second transmitter and a second receiver coupled to the second antenna.
